(19) United States
(12) Patent Application Publication
(10) Pub. No.: US 2009/0296075 A1
(43) Pub. Date: Dec. 3, 2009

(54) Imaging Diffraction Based Overlay

(75) Inventors: Jiangtao Hu, Sunnyvale, CA (US); Chandra Saru Saravanan, Fremont, CA (US); Silvio J. Rabello, Palo Alto, CA (US); Zhuan Liu, Fremont, CA (US); Nigel P. Smith, Hsinchu (TW)

Correspondence Address: Silicon Valley Patent Group LLP, 18805 Cox Avenue, Suite 220, Saratoga, CA, 95070, US

(73) Assignee: Nanometrics Incorporated, Milpitas, CA (US)

(21) Appl. No.: 12/129,448

(22) Filed: May 29, 2008

(51) Int. Cl. G01N 21/00

(52) U.S. Cl. 356/73

(57) ABSTRACT

An overlay error is determined using a diffraction based overlay target by generating a number of narrow band illumination beams that illuminate the overlay target. Each beam has a different range of wavelengths. Images of the overlay target are produced for each different range of wavelengths. An intensity value is then determined for each range of wavelengths. In an embodiment in which the overlay target includes a plurality of measurement pads, which may be illuminated and imaged simultaneously, an intensity value for each measurement pad in each image is determined. The intensity value may be determined statistically, such as by summing, finding the mean or median of the intensity values of pixels in the image. Spectra is then constructed using the determined intensity value, e.g., for each measurement pad. Using the constructed spectra, the overlay error may then be determined.

### FIELD OF THE INVENTION

The present invention relates to overlay metrology, and in particular to diffraction based overlay metrology.

### BACKGROUND

Semiconductor processing for forming integrated circuits requires a series of processing steps. These processing steps include the deposition and patterning of material layers such as insulating layers, polysilicon layers, and metal layers. The material layers are typically patterned using a photoresist layer that is patterned over the material layer using a photomask or reticle. Typically the photomask has alignment targets or keys that are aligned to fiduciary marks formed in the previous layer on the substrate. However, as the integrated circuit feature sizes continue to decrease to provide increasing circuit density, it becomes increasingly difficult to measure the alignment accuracy of one patterning step to the previous patterning step. This overlay metrology problem is becoming particularly difficult as overlay alignment tolerances required to provide reliable semiconductor devices are getting increasingly tighter.

Conventional overlay metrology uses imaging of non-diffraction based targets, such as Box-in-Box or Bar-in-Bar targets. These imaging targets typically include a large structure on one layer and a smaller structure on a different layer. The centers of the larger and smaller structures should coincide when the layers are properly aligned. This conventional overlay metrology technique, however, requires high magnification imaging and suffers from disadvantages such as optical distortions and sensitivity to vibration. Moreover, conventional imaging devices suffer from a trade-off between depth-of-focus and optical resolution. Additionally, edge-detection algorithms used to analyze these images for the purpose of extracting overlay error are inaccurate when the imaged target is inherently low-contrast or when the target suffers from asymmetries due to wafer processing.

Diffraction based overlay metrology utilizes overlying gratings that diffract incident light. Data is acquired, e.g., in the form of spectra, from multiple individual pads in the overlay target. The resulting spectra from each pad can then be compared and used to determine the overlay error. Conventionally, diffraction based overlay targets must be large enough that the measurement spot can only be incident on one individual pad at a time because each pad must be measured individually. Accordingly, the diffraction based targets have an undesirably large footprint on the sample. Additionally, due to the time associated with the acquisition of multiple pads, conventional diffraction based overlay measurements have a relatively low throughput.

Thus, there is a need in the semiconductor industry for improved overlay metrology techniques.

### SUMMARY

An overlay error is determined using a diffraction based overlay target by forming multiple images of the overlay target using different narrow ranges of wavelengths. The images can be used to construct spectra for the overlay target and the spectra is used to determine overlay error.

In one embodiment, a plurality of sample beams is generated, each beam having a different range of wavelengths. A diffraction based overlay target is imaged for each sample beam resulting in a plurality of images of the diffraction based overlay target. An intensity value for each of the plurality of images is determined and used to construct a spectrum. The constructed spectrum is then used to determine the overlay error, which is then recorded.

In another embodiment, an apparatus for measuring overlay error includes a light source that produces a plurality of light beams having different ranges of wavelengths, an optical system configured to illuminate a diffraction based overlay target and an image detector positioned to receive images of the diffraction based overlay target illuminated by each of the plurality of light beams having different ranges of wavelengths. A processor is coupled to the image detector and receives the images of the diffraction based overlay target illuminated by each of the plurality of light beams. The processor includes a computer-readable storage medium storing a computer program executable by the processor and the computer program includes instructions for determining an intensity value for each of the plurality of images; combining the determined intensity values for each of the plurality of images to produce a constructed spectrum; using the constructed spectrum to determine an overlay error; and recording the overlay error.

In another embodiment, the overlay error is determined using a diffraction based overlay target that includes a plurality of measurement pads. In this embodiment, narrow band illumination beams each having a different range of wavelengths are repeatedly generated. Each narrow band illumination beam simultaneously illuminates the plurality of measurement pads in the diffraction based overlay target. The plurality of measurement pads in the diffraction based overlay target are repeatedly imaged to produce an image of the plurality of measurement pads for each range of wavelengths. An intensity value for each measurement pad in each image is determined for each range of wavelengths and used to construct spectra for each measurement pad. The constructed spectra for each measurement pad is then used to determine the overlay error, and the overlay error is recorded.

In another embodiment, after determining the optimal range of wavelength for a specific application, a band pass filter or equivalent is inserted in the illumination light path to allow this range of wavelength to illuminate the target. An intensity value for each measurement pad is determined for this range of wavelengths. Using the intensity values for the measurement pads, the overlay error is determined and recorded.

### BRIEF DESCRIPTION OF THE DRAWINGS

FIG. 1 shows a block diagram of a metrology device that images diffraction based overlay targets in accordance with an embodiment of the present invention.

FIG. 2 illustrates a top view of one embodiment of an overlay metrology target within an illumination spot, in accordance with an embodiment of the present invention.

FIG. 3 is a flow chart describing measuring overlay error using imaging of diffraction based overlay targets, in accordance with one embodiment of the present invention.

FIG. 4 illustrates an image of a single measurement pad that includes a top pattern and an underlying bottom patter, and shows an area of the image that is used to determine the intensity for the measurement pad.

FIG. 5 illustrates a spectrum that is constructed for a single measurement pad in a diffraction based overlay target using a plurality of intensity values.

FIG. 6 illustrates one embodiment of a metrology target, in which four measurement pads are used to determine the overlay error.

FIG. 7 illustrates a top view of an overlay target that uses three-dimension grating pads that may be used in accordance with the present invention.

FIG. 8 is a flow chart describing measuring overlay error using imaging of diffraction based overlay targets, in accordance with another embodiment of the present invention.

### DETAILED DESCRIPTION

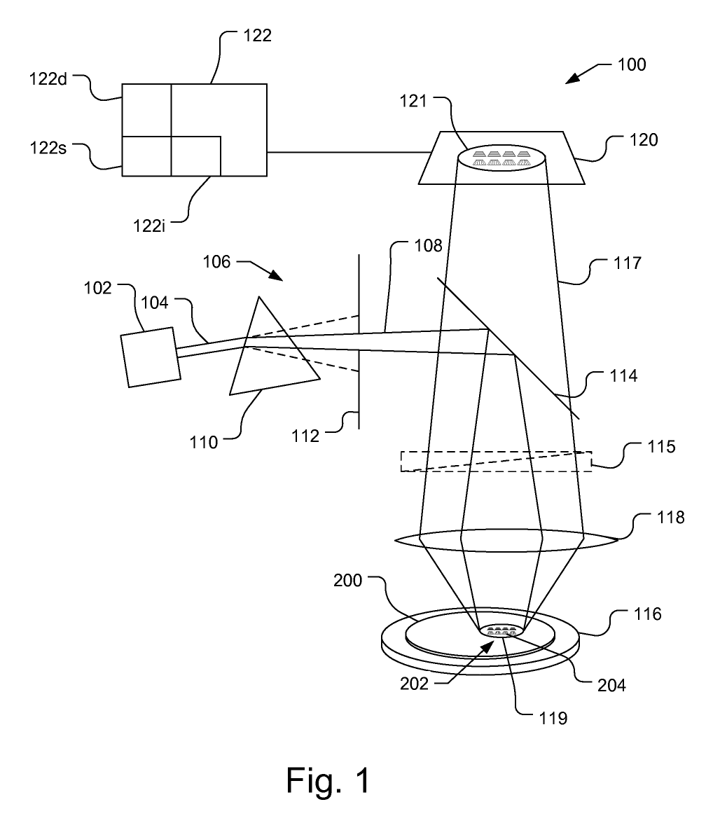

In accordance with an embodiment of the present invention, overlay errors between patterning steps are measured by imaging the diffraction based overlay target. FIG. 1 shows a block diagram of a metrology device 100 that images diffraction based overlay targets in accordance with an embodiment of the present invention. Metrology device 100 images a plurality of measurement pads 204 of a diffraction based metrology target 202 simultaneously. Metrology device 100 produces separate images of the target 202 for multiple narrow bands of wavelengths, then combines the images, or data from the images, to construct spectra for each pad 204 in the target 202. The constructed spectra can then be used to determine the overlay error.

Metrology device 100 uses a broadband light source 102 that generates a broadband light beam 104. By way of example, broadband light source 102 may be a Xenon lamp or other appropriate light supply or supplies that produce a desired broad range of wavelengths. A narrow band pass filter, such as monochromator 106 receives the beam 104 and generates a narrow band illumination beam 108, which has a narrow band of wavelengths. As illustrated in FIG. 1, the monochromator 106 may be produced using a prism 110, which separates the wavelengths in the broadband light beam 104, and a movable slit 112 that selects the narrow band of wavelengths to be passed as beam 108. By using a small slit 112, e.g., 100-500 cm, a very small band of wavelengths, e.g., 1-5 nm wide or less, may be selected. The slit width may be adjusted to balance the spectral resolution and illumination intensity. One or both of the prism 110 and slit 112 are movable so that selectable ranges of wavelengths may be passed as beam 108. The use of monochromator 106 is advantageous as it can provide a continuous range of bands for the beam 108. Of course, if desired other monochromators may be used. By way of example, a diffraction grating may be used in place of the prism 110 or a high speed notch filter may be used in place of the slit 112. Moreover, if desired, liquid crystal selectors or other tunable narrow band pass filters may be used. Alternatively, the monochromator 106 may be eliminated if the light source 102 uses an illumination source that can produce different wavelengths of light, such as a tunable laser diode or a number of illumination sources that produce light having different wavelengths, such as multiple lasers, laser diodes.

The narrow band beam 108 is partially reflected by a beam splitter 114 towards the sample 200 having a diffraction based overlay target 202 with a plurality of measurement pads 204. The sample 200 may be, e.g., a semiconductor wafer or flat panel display or any other substrate, and is supported by a stage 116, which may be a polar coordinate, i.e., R-θ, stage or an x-y translation stage. The beam 108 is focused at normal incidence by an optical system, such as lens 118 (or series of lenses), to form an illumination spot 119 on the sample 200. In one embodiment, the spot 119 is large enough to cover a plurality of or all of the measurement pads 204 in the overlay target 202. The lens 118 may have a high NA, such as 0.5 to 0.7. If desired, polarized light may be used, e.g., using polarizer 115. Alternatively two polarizers may be used, one between the light source 102 and the beam splitter 114 and another between the beam splitter 114 and detector 120.

The image 121 of the target 202 is resolved on a detector 120 by lens 118 through the beam splitter 114, as illustrated by beam 117. Additional lenses, e.g., between the beam splitter 114 and the detector 120 may be used to resolve the image 121 on the detector 120 if desired. The detector 120 is a two dimensional photodetector array, such as a high speed CCD array, CMOS array, or other appropriate device. The image of the target 202 is received by a processor 122 and stored in memory 122s. The processor 122 includes a computer-usable medium 122i having computer-readable program code embodied therein for causing the processor to control the device 100 and to perform a desired analysis, as described herein. The data structures and software code for automatically implementing one or more acts described in this detailed description can be implemented by one of ordinary skill in the art in light of the present disclosure and stored on a computer readable storage medium, which may be any device or medium that can store code and/or data for use by a computer system such as processor 122. The computer-usable medium 122i may be, but is not limited to, magnetic and optical storage devices such as disk drives, magnetic tape, compact discs, and DVDs (digital versatile discs or digital video discs). The processor 122 also includes storage 122s and a display 122d for storing and/or displaying the results of the analysis of the data.

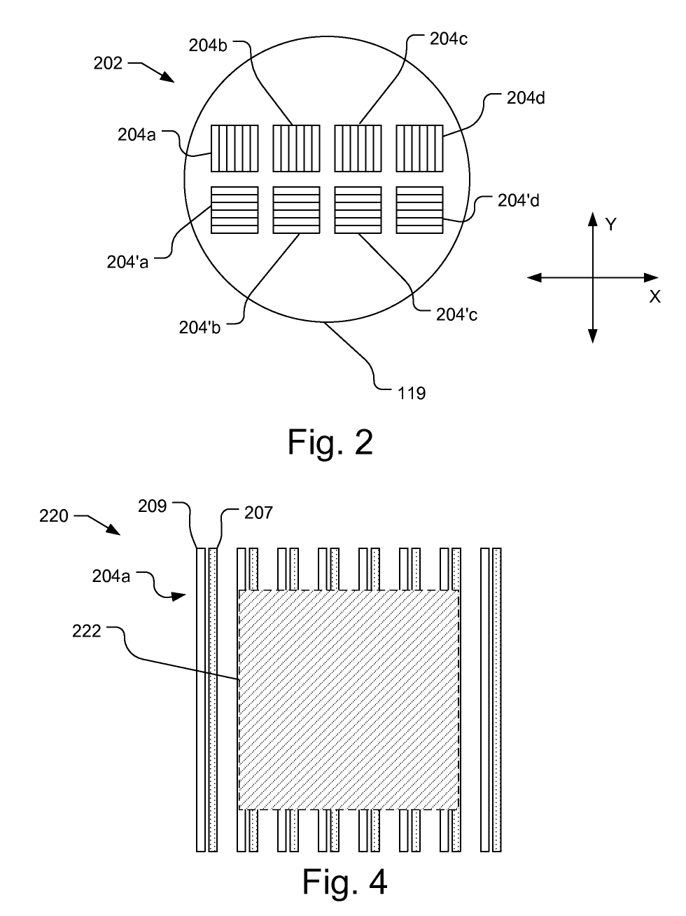

FIG. 2 illustrates a top view of one embodiment of an overlay metrology target 202 within the illumination spot 119, in accordance with an embodiment of the present invention. As illustrated in FIG. 2, the overlay target 202 includes multiple measurement pads 204a, 204b, 204c, and 204d (collectively referred to herein as measurement pads 204) that measure overlay error in one direction, i.e., the X direction, and another set of measurement pads 204′a, 204′b, 204′c and 204′d that measure the overlay error in the orthogonal direction, i.e., the Y direction. With the present invention, the overlay target 202 may have any desired arrangement of measurement pads 202 and it does not have to have the arrangement illustrated in FIG. 2. The measurement spot 119 may cover all the measurement pads 204 in the overlay metrology target 202, or if desired only the measurement pads used to determine overlay in a single direction, e.g., pads 204a, 204b, 204c, and 204d that measure overlay error in the X direction. If desired, the spot 119 may be large enough to cover additional metrology targets as well.

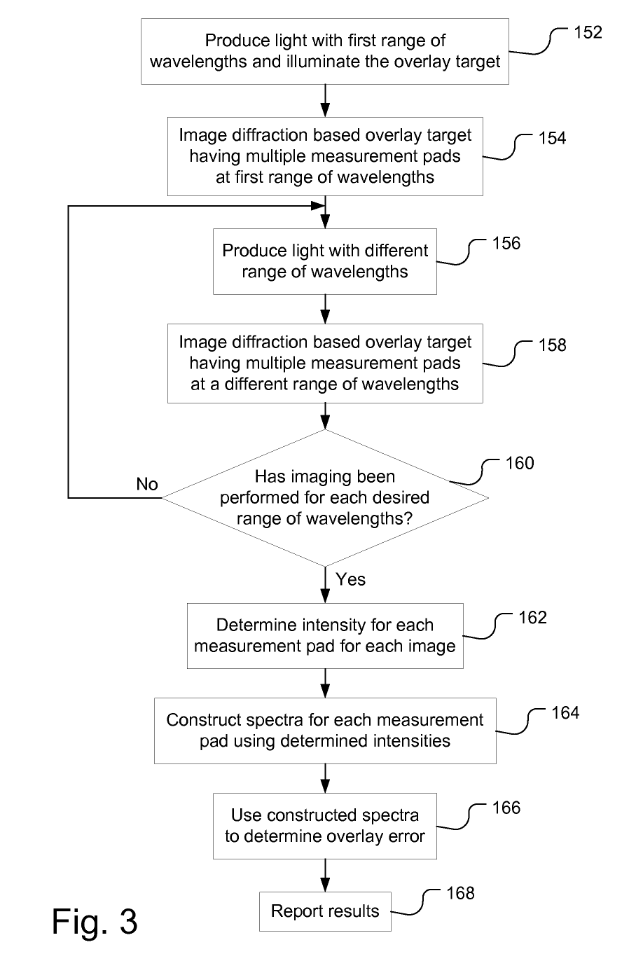

FIG. 3 is a flow chart describing measuring overlay error by imaging of diffraction based overlay targets, in accordance with one embodiment. As illustrated in FIG. 3, light with a first range of wavelengths is produced and illuminates the diffraction based overlay target 202 (block 152). The range of wavelengths should be 1 nm to 10 nm wide, but that preferably a smaller range of wavelengths, e.g., less than 5 nm, and more preferably a single wavelength, is used. The range of wavelengths may be selected, e.g., using monochromator 106, shown in FIG. 1.

The illuminated overlay target 202 is then imaged using the first range of wavelengths (block 154). The diffraction based overlay target 202 includes multiple measurement pads 204, which may be imaged simultaneously as illustrated in FIGS. 1 and 2. By simultaneously imaging all the measurement pads 204, there is no need to move the sample 200 to measure individual measurement pads, which would increase throughput. Moreover, because the measurement pads 204 are not individually measured, the size of the measurement pads 204 and the total size of the overlay target 202 may be relatively small. For example, with a conventional system in which each measurement pad 204 is individually measured using a focused light spot 30 μm in diameter, each measurement pad 204 must be larger than 30 μm so that the entire light spot can be focused on the measurement pad 204. With the present invention, however, the entire overlay target 202 can be smaller than the light spot. By way of example, each measurement pad 204 may be less than 20 μm separated by a distance of 5 μm and the spot size may have a diameter greater than 45 μm, for example 100 μm. Further, higher precision in the measurement may be achieved, as intensity fluctuations during sequential pad measurements are avoided. Additionally, intensity fluctuations during the wavelength measurements do not impact precision because each wavelength is tracked independently.

The range of wavelengths is then changed so that a different range of wavelengths is produced (block 156). The diffraction based overlay target 202 is again imaged time using the different range of wavelengths (block 158). The range of wavelengths is changed and additional images are taken of the overlay target until images have been formed for all desired ranges of wavelengths (block 160).

An intensity value for each measurement pad 204 in each image is determined (block 162). If desired, the intensity value for each measurement pad 204 may be determined prior to or after imaging the overlay target at a different range of wavelengths. In one embodiment, the intensity value of each measurement pad 204 is determined by summing the intensities of each pixel in an image of the measurement pad 204. Of course, if desired other statistical techniques may be used to generate the intensity for each pad for each image, such as finding the median or mean of the intensities of the pixels, or other similar techniques. In one embodiment, the intensity value for each measurement pad 204 is determined using less than all the pixels in the image of the measurement pad 204. By way of example, the central 50% to 90% of the pixels in the image of a measurement pad 204 may be used. FIG. 4, by way of example, illustrates an image 220 of a single measurement pad 204a, that includes the top pattern 209 and the underlying bottom patter 207. It should be understood, however, that while only one measurement pad 204a is shown in FIG. 4, the image of the overlay target 202 may include all of the measurement pads 204. As illustrated in FIG. 4, only a portion of the pixels that form the image of the measurement pad 204a, illustrated as area 222 of the image 220, is used to determine the intensity for the measurement pad 204a. For each image at the different wavelengths, it is desirable to determine the intensity value for each measurement pad using the same pixels.

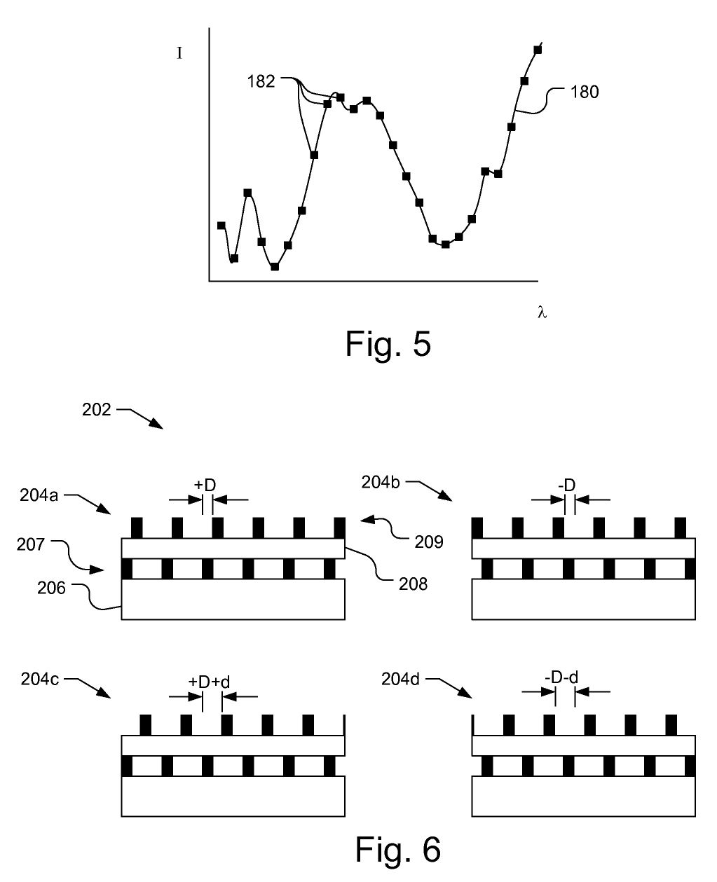

Once an intensity value for each measurement pad 204 in each image is determined, the spectra for each measurement pad is constructed (block 164). The constructed spectrum for each measurement pad consists of the determined intensity values I for each wavelength range λ corresponding to each image. FIG. 5 illustrates a spectrum 180 that is constructed for a single measurement pad, e.g., measurement pad 204a, using a plurality of points 182 that represent the intensity I at wavelength λ. The spectrum 180 is generated as the intensity profile on a discrete set of wavelengths λ.

Once the spectra for each measurement pad 204 is constructed, the overlay error can be determined using known methods (block 166) and the results are recorded (block 168), e.g., by storing in memory, such as storage 122s (FIG. 1) in processor 122 or by displaying to the user by display 122d, which may be a monitor, printer, or another appropriate device.

The method of determining overlay error depends on the type of metrology target used. FIG. 6, for example, illustrates one embodiment of a metrology target 202, in which four measurement pads 204 are used to determine the overlay error in one direction, e.g., along the X axis, shown in FIG. 2. The four individual measurement pads 204a, 204b, 204c, and 204d include a bottom layer 206 with a diffraction pattern 207, and a top layer 208 with a diffraction pattern 209. The pattern 209 on the top layer 208 overlies the pattern 207 on the bottom layer 206. It should be understood that additional layers may be present between the top layer 208 and the bottom diffraction pattern 207. Alternatively, the two layers 209 and 207 may be present on the same level.

When the top layer 208 is perfectly aligned with the bottom layer 206, the top pattern 209 will be offset slightly with respect to the bottom layer 207. The offset of each measurement pad 204 is different in magnitude and/or direction. By way of example, measurement pad 204a has an offset that has a magnitude of D towards the right, referred to herein as +D, while measurement pad 204b has an offset of the same magnitude by towards the left, referred to herein as −D. Measurement pads 204c and 204d include the same magnitude offset, i.e., D, with a reference offset. Thus, measurement pad 204c has an offset towards the right with a magnitude of +D+d, and the measurement pad 204d has an offset that is the same magnitude, i.e., |D+d|, but in an opposite direction towards the left, and is referred to herein as −D−d. The magnitude of the reference offset d can be fairly small, e.g., approximately 1% to 15% and in particular 5% of the pitch of the patterns. Of course, the precise magnitude and direction of designed in offset D and reference offset d may be varied to suit the particular materials and dimensions of the overlay patterns, along with the wavelength or wavelengths of light used by the metrology equipment.

With the use of metrology target 202 show in FIG. 6, the diffractions of measurement pads 204 are measured, e.g. using the metrology instrument and methodology described in FIGS. 1 and 3. Intensity spectra from the four measured pads (a, b, c. and d) as shown in FIG. 6 may be used to calculate the overlay error e as follows:

$$e = \frac{( Ra - Rb ) + ( Rc - Rd )}{( Rc - Ra ) + ( Rd - Rb )} \cdot \frac{d}{2} \qquad eq . 1$$

where Ra, Rb, Rc, and Rd are the intensities at selected wavelengths of the constructed spectra for measurement pads 204a, 204b, 204c, 204d and d is the absolute value of the reference offset.

If desired, different types of overlay targets may be used with the present invention. For example, U.S. Pat. No. 6,982,793, which is incorporated herein by reference, describes the overlay target 202 shown in FIG. 6, as well as other overlay targets that may be used with the present invention. For example, instead of four measurement pads 204, fewer or more measurements pads may be used. Moreover, instead of two-dimensional gratings formed of lines and spaces, three-dimensional diffraction patterns may be used. With the use of three-dimensional patterns, the overlay error in the X direction and the Y direction may be determined using the same set of measurement pads.

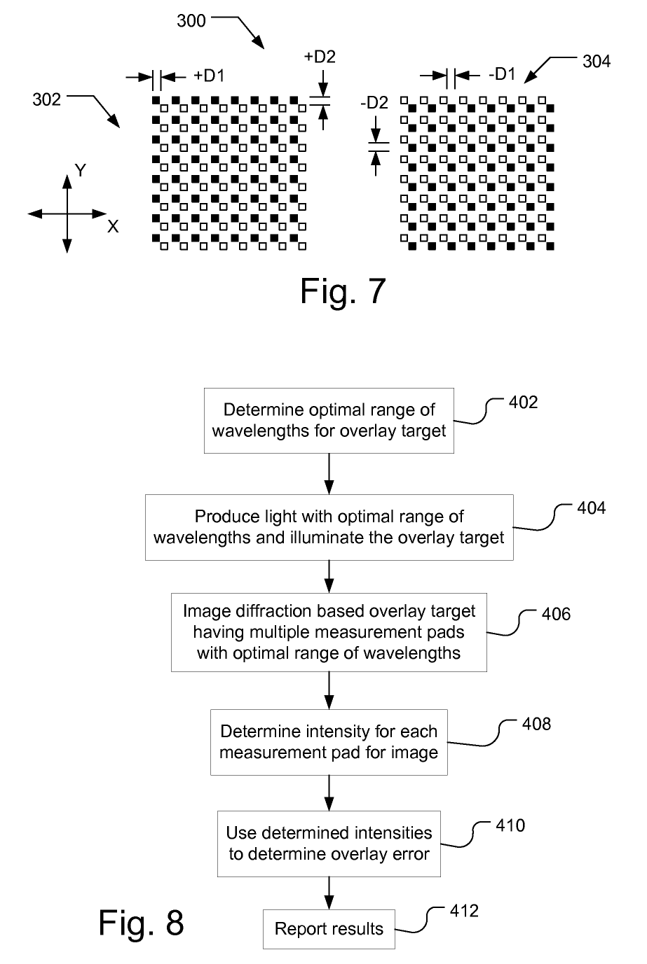

By way of example, FIG. 7 illustrates a top view of an overlay target 300 that includes two three-dimension grating pads 302,304 that may be used in accordance with the present invention. Instead of a series of lines that extend in one direction, the overlay target 300 includes a series of squares that extend in two directions, i.e., the X and Y directions. The black squares in FIG. 7 illustrate, e.g., the bottom diffraction grating, while the white squares illustrate the top diffraction grating. If desired, the gratings may be on the same level or have multiple layers between them. Overlay target 300, includes a designed in offset ±D1 in the X direction and a designed in offset ±D2 in the Y direction. The magnitude of offsets D1 and D2 may be the same or different. If desired, the grating may be formed using other shapes besides squares, e.g., rectangles, circles, ellipses, or other polygonal shapes including non-symmetrical shapes.

In general, to measure the alignment error e it is necessary to determine the change in the diffracted light with respect to the change in alignment error. This may be written as follows:

$$ϕ = \frac{\partial R}{\partial e} \qquad eq . 2$$

where R is the measured light at selected wavelengths and e is the alignment error. The factor φ for an overlay target maybe determined using, e.g., modeling techniques or using additional measurement locations as reference locations, as discussed above. Once the factor φ is determined, the value of the overlay error e can then be determined using the following equation.

Ra−Rb=2eφ eq. 4

where Ra and Rb are the intensities at selected wavelengths of the constructed spectra for measurement pads 302 and 304.

FIG. 8 is a flow chart describing measuring overlay error by imaging of diffraction based overlay targets, in accordance with another embodiment. As illustrated in FIG. 8, the optimal range of wavelengths for the overlay target is determined (block 402). The optimal range may be determined, e.g., experimentally or through simulation. The optimal range of wavelengths may be the range of wavelengths that are the most sensitive to overlay error with the target being measured. The optimal range of wavelengths may be anywhere in the spectrum and may be from 1 nm to 100 nanometers wide, by way of example. Light having the optimal range of wavelengths is then produced and used to illuminate the diffraction based overlay target 202 (block 404). The range of wavelengths may be selected, e.g., using monochromator 106, a band pass filter or other appropriate optical element.

The illuminated overlay target 202 is then imaged using the optimal range of wavelengths (block 406). As discussed above, the diffraction based overlay target 202 includes multiple measurement pads 204, which may be imaged simultaneously as illustrated in FIGS. 1 and 2. By simultaneously imaging all the measurement pads 204, there is no need to move the sample 200 to measure individual measurement pads, which would increase throughput. An intensity value for each measurement pad 204 for the image is determined (block 408). The intensity value may be determined as discussed above in reference to FIG. 3. The determined intensities for each measurement pad 204 is then used to determine the overlay error using, e.g., equation 4 above (block 410), and the results are recorded (block 412), e.g., by storing in memory, such as storage 122s (FIG. 1) in processor 122 or by displaying to the user by display 122d, which may be a monitor, printer, or another appropriate device.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A method comprising:
generating a plurality of sample beams, each sample beam having a different range of wavelengths;
imaging a diffraction based overlay target for each sample beam resulting in a plurality of images of the diffraction based overlay target;
determining an intensity value for each of the plurality of images;
constructing a spectrum using the determined intensity value for each of the plurality of images;
using the constructed spectrum to determine an overlay error; and
recording the overlay error.

2. The method of claim 1, wherein the range of wavelengths is less than 10 nm.

3. The method of claim 1, wherein the range of wavelengths is less than 5 nm.

4. The method of claim 1, wherein the diffraction based overlay target comprises a plurality of measurement pads, imaging a diffraction based overlay target comprises imaging the plurality of measurement pads simultaneously, and determining an intensity value comprises determining an intensity value for each measurement pad for each of the plurality of images, the method further comprising:
constructing spectra for each measurement pad using the determined intensity value for each measurement pad for each of the plurality of images and using the constructed spectra to determine an overlay error.

5. The method of claim 4, wherein each measurement pad comprises overlying diffraction patterns.

6. The method of claim 4, wherein each measurement pad comprises two diffraction patterns that are on the same layer.

7. The method of claim 1, wherein determining an intensity value for each of the plurality of images comprises analyzing an intensity value of a plurality of pixels for each image.

8. The method of claim 7, wherein analyzing an intensity value of a plurality of pixels for each image comprises at least one of summing the intensity values of the plurality of pixels, finding the mean intensity value for the plurality of pixels, and finding the median intensity value for the plurality of pixels.

9. The method of claim 7, wherein the plurality of pixels is less than all the pixels in each image.

10. An apparatus for measuring overlay error using a diffraction based overlay target, the apparatus comprising:
a light source that produces a plurality of light beams having different ranges of wavelengths;
an optical system configured to illuminate a diffraction based overlay target;
an image detector positioned to receive images of the diffraction based overlay target illuminated by each of the plurality of light beams having different ranges of wavelengths; and
a processor coupled to the image detector and receiving the images of the diffraction based overlay target illuminated by each of the plurality of light beams having different ranges of wavelengths, the processor having a computer-readable storage medium storing a computer program executable by said processor, the computer program comprising computer instructions for determining an intensity value for each of the plurality of images; combining the determined intensity values for each of the plurality of images to produce a constructed spectrum; using the constructed spectrum to determine an overlay error; and recording the overlay error.

11. The apparatus of claim 10, wherein the light source that produces a plurality of light beams having different ranges of wavelengths comprises:
a broadband illumination source that produces broadband light; and
a narrow band pass filter for selecting a desired range of wavelengths to pass, wherein the plurality of light beams are produced by selecting different desired ranges of wavelengths to pass.

12. The apparatus of claim 11, wherein the narrow band pass filter comprises a monochromator.

13. The apparatus of claim 12, wherein the monochromator comprises a diffracting element to separate the wavelengths in the broadband light and one of a slit and a high speed notch filter to select the desired range of wavelengths to pass.

14. The apparatus of claim 13, wherein the diffracting element is a prism.

15. The apparatus of claim 11, wherein the narrow band pass filter comprises a liquid crystal selector.

16. The apparatus of claim 10, wherein the diffraction based overlay target comprises a plurality of measurement pads, the optical system is configured to illuminate the plurality of measurement pads simultaneously and the image detector is positioned to receive an image of the plurality of measurement pads for each of the plurality of light beams having different ranges of wavelengths.

17. The apparatus of claim 16, wherein each measurement pad comprises overlying diffraction patterns.

18. The apparatus of claim 16, wherein each measurement pad comprises two diffraction patterns that are on the same layer.

19. The apparatus of claim 16, wherein the computer instructions for determining an intensity value for each measurement pad in each of the plurality of images; combining the determined intensity values for each measurement pad in each of the plurality of images to produce constructed spectra; and using the constructed spectra to determine the overlay error.

20. The apparatus of claim 10, wherein the computer instructions for determining an intensity value for each of the plurality of images comprises analyzing an intensity value of a plurality of pixels in the image detector for each image.

21. The apparatus of claim 20, wherein analyzing an intensity value of a plurality of pixels in the image detector for each image comprises at least one of summing the intensity values of the plurality of pixels, finding the mean intensity value for the plurality of pixels, and finding the median intensity value for the plurality of pixels.

22. The apparatus of claim 20, wherein the plurality of pixels is less than all the pixels in each image.

23. A method of determining an overlay error with a diffraction based overlay target that includes a plurality of measurement pads, the method comprising:
repeatedly generating narrow band illumination beams each having a different range of wavelengths, wherein each narrow band illumination beam simultaneously illuminates the plurality of measurement pads in the diffraction based overlay target;
repeatedly imaging the plurality of measurement pads in the diffraction based overlay target to produce an image of the plurality of measurement pads for each range of wavelengths;
determining an intensity value for each measurement pad in each image for each range of wavelengths;
constructing spectra for each measurement pad using the determined intensity value for each measurement pads in each image;
using the constructed spectra for each measurement pad to determine the overlay error; and
recording the overlay error.

24. The method of claim 23, wherein the range of wavelengths in each narrow band illumination beam is less than 10 nm.

25. The method of claim 23, wherein the range of wavelengths in each narrow band illumination beam is less than 5 nm.

26. The method of claim 23, wherein determining an intensity value for each measurement pad in each image for each range of wavelengths comprises analyzing intensity values of a plurality of pixels for each measurement pad in each image.

27. The method of claim 26, wherein analyzing an intensity values of the plurality of pixels for each measurement pad comprises at least one of summing the intensity values, finding the mean intensity value, and finding the median intensity value.

28. The method of claim 26, wherein the plurality of pixels for each measurement pad is less than all the pixels for each measurement pad and the plurality of pixels is approximately in the center of each measurement pad.

29. The method of claim 23, wherein each measurement pad comprises overlying diffraction patterns.

30. The apparatus of claim 16, wherein each measurement pad comprises two diffraction patterns that are on the same layer.

31. The method of claim 23, wherein each measurement pad comprises two diffraction patterns that are on the same layer.

32. A method comprising:
determining a range of wavelengths that are sensitive to overlay errors for a diffraction based overlay target that comprises a plurality of measurement pads,
generating a sample beams having the range of wavelengths;
imaging the plurality of measurement pads in the diffraction based overlay target simultaneously using the sample beam resulting in an image of the diffraction based overlay target;
determining an intensity value for each measurement pad from the image of the plurality of measurement pads;
using the determined intensity value for each measurement pad to determine an overlay error; and
recording the overlay error.

33. The method of claim 32, wherein the range of wavelengths is less than 100 nm.

34. The method of claim 32, wherein each measurement pad comprises overlying diffraction patterns.

35. The method of claim 32, wherein each measurement pad comprises two diffraction patterns that are on the same layer.

36. The method of claim 32, wherein determining an intensity value for each of measurement pad comprises analyzing an intensity value of a plurality of pixels for each measurement pad.

37. The method of claim 36, wherein analyzing an intensity value of a plurality of pixels for measurement pad comprises at least one of summing the intensity values of the plurality of pixels, finding the mean intensity value for the plurality of pixels, and finding the median intensity value for the plurality of pixels.

38. The method of claim 36, wherein the plurality of pixels is less than all the pixels in each measurement pad.
